(19) United States
(12) Patent Application Publication
(10) Pub. No.: US 2005/0228984 A1
(43) Pub. Date: Oct. 13, 2005

(54) Web service gateway filtering

(75) Inventors: Yigal Edery, Pardesia (IL); Ron Mondri, Bellevua, WA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/819,567

(22) Filed: Apr. 7, 2004

(51) Int. Cl. H04L 9/00

(52) U.S. Cl. 713/153

(57) ABSTRACT

A firewall device implements policies for a destination web service, where the policies determine the access rights of clients and other web services to services that are available at the destination web service. The clients and web services send requests in the form of web service messages which are processed by the firewall server based on the policies.

### TECHNICAL FIELD

This invention relates to a web service filter that implements policies and based on the policies processes incoming web service messages prior to receipt of the messages by a web service and processing outgoing messages from a web service.

### BACKGROUND

Web services implement standardized methods of integrating applications that allow organizations (i.e., web services, clients, etc.) to communicate data, logic, and processes through a network such as the Internet. Web services do so by using a programmatic interface instead of a providing a GUI (graphical user interface) used in traditional web page systems. The programmatic interface allows different web-based applications or messages from different sources (i.e., web services, clients, etc.) to communicate to one another. Also unlike traditional web page systems, web services do not use browsers or HTML (hyper text markup language). Furthermore, the web-based applications are not constrained to a particular operating system, such that web services using operating systems different than other web services (or clients) may exchange or provide applications with or to the other web services (or clients).

Web services generally use open standards that include XML (extensible markup language), SOAP (simple object access protocol), WSDL (web service description language), and UDDI (universal description, discovery, and integration). SOAP is particularly used to transfer data (i.e., provide a web service application) over a particular transport protocol such as HTTP (hyper text transfer protocol), SMTP (simple mail transfer protocol), and FTP (file transfer protocol). A SOAP message (also referred to as a SOAP envelope) includes a header and a body of tagged data expressed as an XML listing. WSDL is used to describe what a web service offers, and UDDI is used to list available web services (i.e., UDDI is a registry of web services, which uses WSDL as a language).

Evolving web service standards include GXA (global XML web services architecture), WS-Security (web service security), and WS-Policy (web service policy). GXA includes infrastructure protocols to address web service security and authentication, transactions, and routing of requests (i.e., web service messages). WS-Security particularly provides that requests or web service messages have not been modified (i.e., validation of a client message) and verification of client credential before the request or message is received by a web service. WS-Policy defines a model and XML syntax that describes and communicates the policies of a web service.

Since a request or message which may be implemented as a SOAP envelope may go through one or several intermediaries between the originating web service or client and the web service, validation and verification are important aspects of protecting the web service. In addition to basic message validation, WS-Security defines ways to ensure the integrity and authenticity of the message, and may be verified in a firewall computer supporting a web service. Web services may provide different access rights to applications to different web services or clients, therefore policy management or rules are needed to distinguish which clients or other web services are to be provided particular access rights.

Firewall filters are able to distinguish clients and perform validation and verification; however, they are not able to distinguish what particular access rights are given to other web services or clients. A web service may implement policy management using WS-Policy on the web service applications; however, this involves modifying the applications at the web service and performing an analysis of other web services or clients that attempt to communicate. In other words, the particular web service and in particular the web service administrator is tasked to develop and enforce policy management that affects communication with other web services or clients.

### SUMMARY

A firewall device has web service filters and processors that verify web service messages and access rights granted to clients originating the web services messages based on policies applied at the firewall device. The policies define particular access rights of clients to applications available from a destination web service.

### BRIEF DESCRIPTION OF THE CONTENTS

The detailed description is described with reference to the accompanying figures. In the figures, the left-most digit(s) of a reference number identifies the figure in which the reference number first appears. The use of the same reference numbers in different figures indicates similar or identical items.

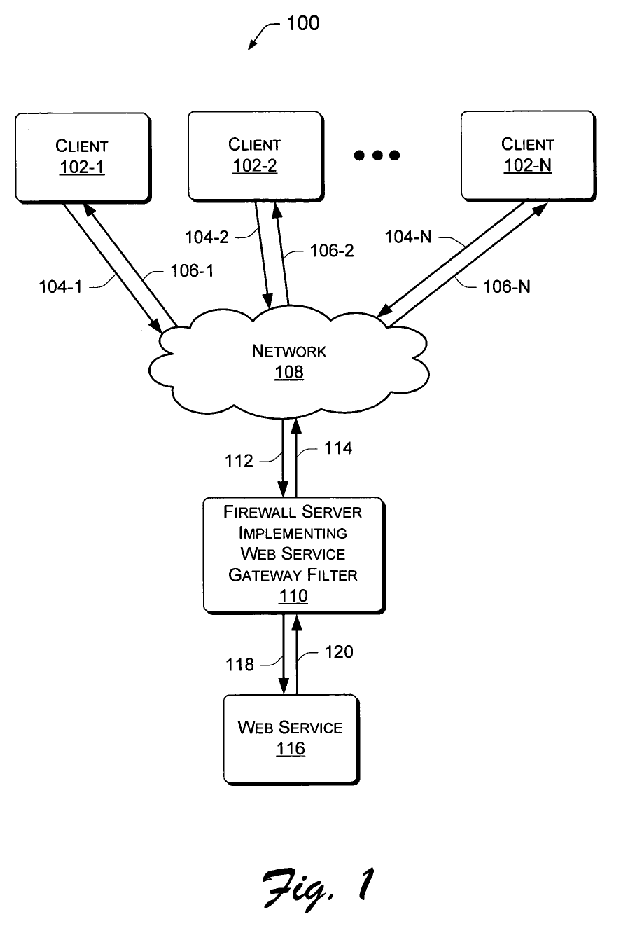

FIG. 1 is a block diagram illustrating a web service system.

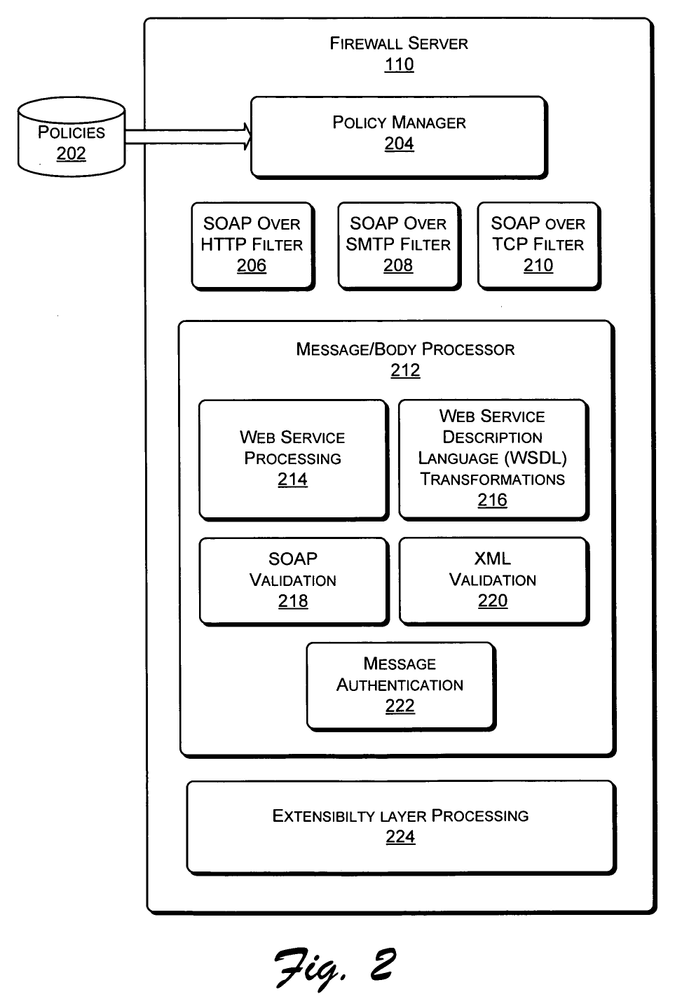

FIG. 2 is a block diagram illustrating firewall server that includes a policy manager that filters and processes received messages.

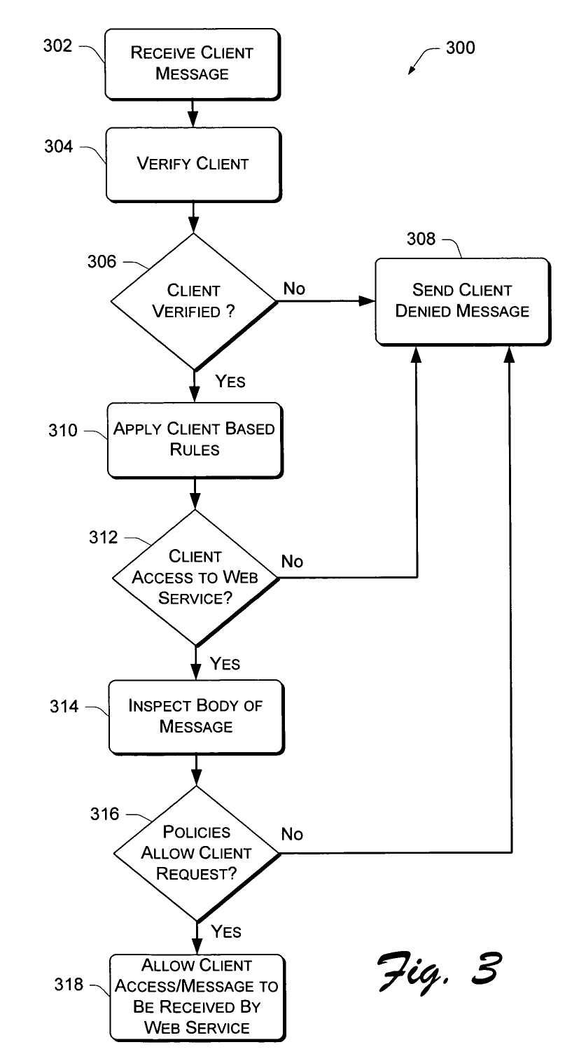

FIG. 3 is a flow diagram showing a process for implementing policies for a web service.

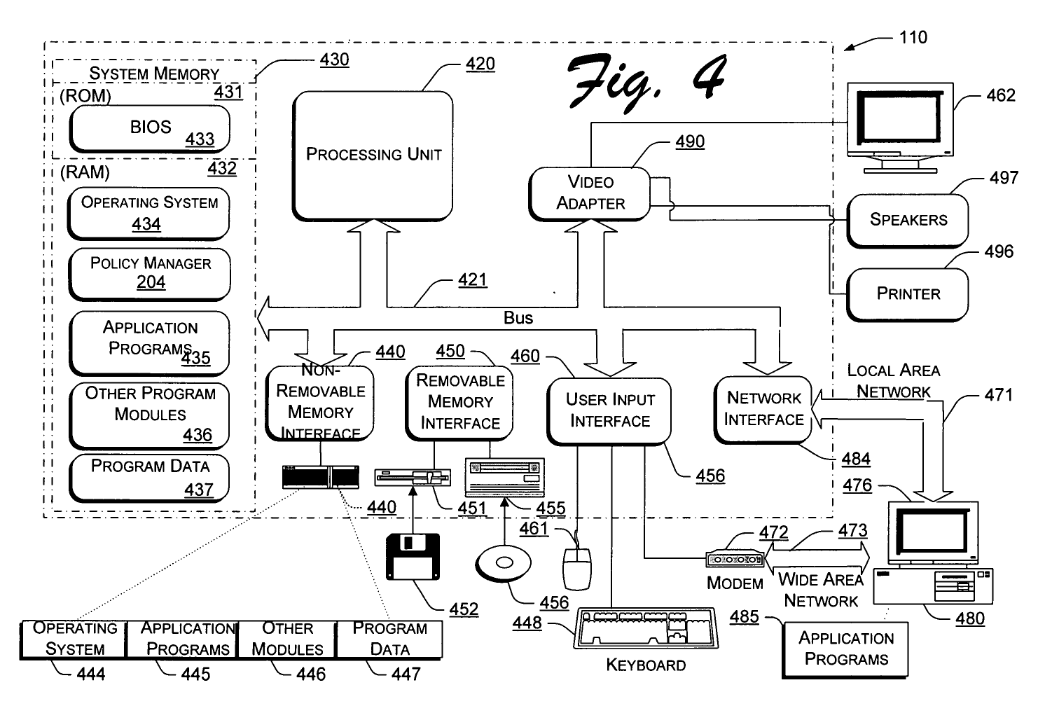

FIG. 4 is a block diagram of an exemplary server or computing device environment for practicing the subject matter.

### DETAILED DESCRIPTION

The following disclosure describes a policy manager and web service filters in a firewall server (i.e., computer) that provides message validation and policy management for communication between a destination web service and other web services and clients. In particular the policy manager and web service filters determine access rights of the other web services or clients to web-services protected by the firewall server.

Web Service System

FIG. 1 shows an exemplary web service system 100. Web service system 100 allows exchange or transport of web service data or web service messages between web services and clients. In this example, one or more web service or client computers (clients) 102-1, 102-2 to 102(N) respectively send web service messages 104-1, 104-2 to 104-N and receive web service messages 106-1, 106-2 to 106-N.

Web service data, which may also be referred to as web service messages (e.g., web service messages 104 and 106) may be defined as a particular structure that includes for example XML listings, XML packets, XML messages, SOAP messages, and other defined (i.e., well formed) data structures. In the example implementations that follow, SOAP messages may be used as particular examples of web service data or web service messages. Well formed messages are defined as conforming to a particular data structure or schema such as a SOAP message schema.

Web service messages 104 may include invocations to URLs (universal resource locators) of web services, and further may include a request to access or receive data from the web services. Web service messages 104 may be sent as XML listings, and in particular XML listings in SOAP messages (i.e., SOAP envelopes) that include a header and a body. Web service messages 104 are transported over one or more of several transportation protocols which include HTTP (hyper text transfer protocol), SMTP (simple mail transfer protocol), TCP (transmission control protocol) and FTP (file transfer protocol). Specifically, web service messages 104 are transferred over a particular transportation protocol layer. Web service messages 104 may be sent directly to a web service or may be routed through one or more intermediaries which may modify web service messages 104 before they arrive at a destination web service.

Web service messages 106 may be returned (i.e., received by clients 102) as XML data matching a previously agreed-upon XML schema definition (XSD). Web service messages 106 may also be implemented as SOAP messages (i.e., SOAP envelopes) received from a web service. Web service messages 106 use a particular transport protocol and are transferred over a particular transportation protocol layer. Preferably web service messages 106 and 104 use the same transport protocol (i.e., HTTP, SMTP, FTP, TCP, etc.).

A network 108 connects clients 102 to each other, and to other clients or web services. Network 108 is configured to receive and pass on web service messages 104 and 106, and to use whatever transportation protocol or protocols that is (are) used by messages 104 and 106. Network 108 includes intranets, extranets, and the Internet.

The network 108 is connected to a firewall server 110, and passes web service messages 112 to and receives web service messages 114 from the firewall server 110. Web service messages 112 include web service messages 104 sent by clients 102 and web service messages from other clients, web services, and intermediary parties. Web service messages 114 may include messages 106 as received by clients 102.

The firewall server 110 receives web service messages 112 from the network 108, and passes web service messages 114 to the network 108. Firewall server 110 may be an ISA (Internet Security and Acceleration) server as defined by the Microsoft Corporation. Firewall server 110 may include one or more filters that perform at one or more layers. In other words, filtering at firewall server 110 may be performed at a packet layer (i.e., packet filtering), a circuit layer (i.e., circuit filtering), and or an application layer (i.e., application filtering). Since web services and particularly web service messages are based on applications (i.e., web-based applications), firewall server 110 particularly makes use of filtering at the application layer or application filtering.

Application filtering examines the data contained in web service messages 112 and performs filtering decisions based on the data. The application filtering may be performed on the data as raw XML data of web service messages 112. A SOAP message filter may be included that examines SOAP messages received as web service messages 112 at firewall server 110 and may act on a header portion or a body portion (or both) of a SOAP message. Particular filters, including a SOAP message filter are further discussed below in reference to FIG. 2.

Firewall server 110 acts as an intermediate gateway to a destination web service 116. In certain cases, firewall server 110 and destination web service 116 are managed or controlled by the same administrator. In other situations management is performed by separate administrators, allowing a web service 116 administrator to maintain web service 116 without having to maintain policies that affect clients and other web services. In this case, the policies implemented by firewall server 110 are defined and maintained by a separate firewall server 110 administrator.

Destination web service 116 receives web service messages 118 from firewall server 110, where web service messages 118 have been filtered per particular policies implemented at firewall server 110. The policy manager and policy implementation at firewall server 110 is further discussed below.

Web service messages 118 include messages 104 and may be in the form of an XML listing or SOAP message. A particular transportation protocol layer is used in transporting messages 118. Transportation protocol filters as described below may reside in the firewall filter which interface directly to a web service (e.g., web service 116), and may be configured to change a transportation protocol of the received web service messages prior to send the web service message to the web service.

Web service messages 120 are sent from destination web service 116 to firewall server 110, where web service messages 120 ultimately are received by a particular requesting client or web service (e.g., clients 102). Web service messages 120 may be formatted as XML listing which may be in the form of a SOAP message that may include data provided by destination web service 116. Web service messages 120 are transported over a particular transportation protocol layer. Replies or web service messages 120 from web service 116 may be processed through another set of validation and policies by firewall 110, like requests or received web service messages 112.

Firewall Server

FIG. 2 shows an exemplary firewall server 110. The firewall server 110 as discussed above may be implemented as an ISA (Internet Security and Acceleration) server as defined by the Microsoft Corporation; however, it is contemplated that firewall server 110 may be implemented using architectures and standards that define other servers, computers, and computing devices.

Policies 202 are shown as being maintained and stored in a separate storage device which may or may not be included in firewall server 110. Policies 202 define particular access rights of clients and web services to a destination web service (e.g., services provided by destination web service 116). Policies 202 may be written in and defined by several languages and standards; however, it is contemplated that policies 202 may make use of the current and evolving WS-Policy specification which defines “policy”, “policy expression”, and “policy assertion”. The WS-Policy specification is authored by BEA Systems, International Business Machines Corporation, Microsoft Corporation, and SAP AG.

WS-Policy defines a generic model and syntax that describe and communicate a particular web service's policies. The term “policy” refers to a set of information expressed as policy assertions. The term “policy assertion” is defined as representing a preference, requirement, capability, or other property. The term “policy expression” is an XML listing representing one or more policy assertions. The term “policy subject” is an entity which a policy expression is bound to. The term “policy attachment” is a mechanism that associates policy expressions to one or more policy subjects.

In the WS-Policy model, clients and web services (e.g., clients 102) are policy subjects that have particular policy assertions which include access rights that are available to access applications that are available from a destination web service (e.g., destination web service 216). The policy assertions are written as policy expressions which are kept in policies 202. In this example firewall server 110 receives policies through a policy manager 204 included in firewall server 110.

Firewall server 110 includes one or more filters that process received messages such as messages 112. A SOAP over HTTP filter 206 is a DLL (data link layer) called by firewall server 110 whenever a message is received over the HTTP transportation protocol layer. In particular, SOAP over HTTP filter 206 is used to determine what notifications (e.g., request for information, replies, etc.) are to be filtered by firewall server 110. For example, if a received message over HTTP contains a notification as to a request for a service from the destination web service (e.g., destination web service 116), SOAP over HTTP filter 206 processes the notification. The SOAP over HTTP 206 is considered an application filter since it processes based on data contained in the received messages.

Other transportation protocol layer filters may be included in firewall server 110. In this example, a SOAP over SMTP filter 208 and SOAP over TCP filter 210 are shown. Filter 208 handles received SOAP messages that are transported over the SMTP transportation protocol layer. Filter 210 handles received SOAP messages that are transported over the TCP transportation protocol layer. Firewall server 110 may include other filters that address other transportation protocol layers (e.g., the FTP transportation protocol layer). Such transportation protocol filters may communicate directly to a web service (e.g., destination web service 116) and may be implemented to modify or provide a different transportation protocol to the web service message prior to sending the web service message to the web service. The transportation protocol filters may also modify or change transportation protocols of web service messages that are received from the web service prior to being sent from firewall server 110. For example, if filter 210 receives a web service message from destination web service 116 in HTTP, filter 210 changes the transportation protocol to TCP prior to firewall server 110 sending the web service message. Modification or change of transportation protocols may be implemented through policy manager 204.

Filters 206, 208, and 210 may perform verification that a client has actually sent the message. Verification may be performed at the transport level (e.g. when HTTP authentication is used). Verification and validation may also be performed at the message level using a separate message authentication module as described below.

Based on policies 202, and particularly the policy assertions (implemented as policy expressions) that associate access rights of clients and web services to web-based applications of a destination web service (e.g., web service 116), filters 206, 208, and 210 may allow particular messages to access particular services or data of a destination web service (e.g., destination web service 116).

Firewall Server 110 further includes message or body processor 212 that acts on data contained in messages going to and coming from a destination web service (e.g., destination web service 116). In this example, processor 212 includes one or more logical modules that perform the particular actions on data contained in the messages going to and coming from the web service (e.g., destination web service 116).

A logical web services processing module 214 processes messages (i.e., data in received and sent messages from the destination web service) and specifically performs security negotiation; enforces authentication and authorization of policies 202 based on access rights of clients or other web services to services available from the destination web service (e.g., destination web service 116); and enforces cryptographic characteristics of sent or received messages from/to the destination web service (e.g., destination web service 116).

As defined by policies 202 and implemented through policy manager 204 and message processing module 212, received web service messages may be determined to be encrypted or not (if not encrypted the message may not be forwarded to the destination web service 116). Furthermore, web policies 202 may define that web service messages that are sent should be encrypted. Module 212 may perform such processes. Web services processing module 212 (through policy manager 204) performs security and business rules (i.e., policy management) based on data or payload contained in a web service message (e.g., SOAP message/SOAP envelope).

A logical web services processing module 216 is used to process WSDL transformations and control the services (i.e., web service data) that are exposed or offered by a destination web service (e.g., destination web service 116). In this example, the services are described by WSDL. Based on access rights of a client or a web service, module 216 exposes or provides access to particular services to the client or web service upon verification (authentication) of the client or web service.

In this example, if SOAP messages are processed, a logical web services processing module 218 performs SOAP message (i.e., SOAP envelope) validation and particular looks at data or payload contained in a SOAP message (i.e., SOAP envelope).

Likewise, a logical web services processing module 220 performs general XML message validation and looks at the data in an XML listing (i.e., the payload in an XML listing). In general modules 218 are used to validate the correctness of the data, compared to known schemas, to ensure no badly formed web service messages reach the destination web service 116. In other words, well formed web messages are sent to destination web service 116.

A message authentication module 222 is included in message/body processor 212. Message authentication module 222 is used to perform message level authentication that includes verification and validation of the received web service message. Verification and validation as performed by message authentication module 222 is similar to transport level verification and validation as described above that are performed by filters 206, 208, and 210.

A logical module 224 is provided for future extensibility. Module 224 provides for a destination web service (i.e., a destination web service or firewall server administrator) to add other data-inspection algorithms that are applied to incoming and outgoing messages received at the firewall server 110 and passed to/from the destination web service (e.g., destination web service 116).

Web Service Policies Implementation

FIG. 3 shows a process 300 for implementing web service policies. The process 300 is illustrated as a collection of blocks in a logical flow graph, which represent a sequence of operations that can be implemented in hardware, software, or a combination thereof. In the context of software, the blocks represent computer instructions that, when executed by one or more processors, perform the recited operations. Process 300 is particular performed at a firewall server such as firewall server 110.

At block 302, client or web service messages are received at the firewall server 110. Messages include messages 118 and may be an XML listing, XML packet, or SOAP message (i.e., SOAP envelope). Such messages include requests for access to (i.e., receive) services from a destination web service (e.g., destination web service 116), or replies of the web service to a previous request.

At block 304, verification of the client or web service that sent the message is performed. Block 304 may be performed by one of the filters 206, 208, or 210 described in FIG. 2. Message authentication module 222 may also perform block 304. In certain cases, verification may be performed logical module 212 of FIG. 2. As described above, verification may be performed using a digital signature in the message, or XML Signature as defined by WS-Security. Verification may also include transport specific verification, such as HTTP authentication.

If client or web service verification fails (i.e., following the “No” branch of block 306), block 308 may be performed which sends a message from the firewall server 110 to the client or web service that originated the message advising the client or web service that the request contained in the message is denied.

If the client or web service is verified (i.e., following the “Yes” branch of block 306), policies or rules regarding particular clients or web services are applied. For example, policies 202 may be processed by one of filters 206, 208, or 210 as to clients or web services that have access rights to services provided by the destination web service (e.g., destination web service 116).

If a client or web service is identified as not having access rights to web-based applications provided by the destination web service (i.e., following the “No” branch of block 312), block 308 may be performed which informs the client or web service that the request contained in the message is denied.

If the client or web service is identified as having access rights to applications provided by the destination web service (i.e., following the “Yes” branch of block 312), block 314 is performed. Block 314 inspects the body (i.e., content or data) of the received message as to particular requests for services provided by the destination web service.

At block 314, policies 202 are processed as to the particular access rights that are available to the requesting client or web service. In particular policies 202 applicable to a particular client or web service is applied. In the case when WS-Policy is used, a client is identified as policy subject bound to a policy expression where the policy expression represents a policy assertion or assertions. Policy assertions define the properties afforded to the policy subject (i.e., client or web service). Through the policy attachment mechanism, WS-Policy also allows multiple policy subjects (i.e., clients and/or web services) to be associated with particular policy expressions (i.e., policy assertions).

Furthermore block 314 may be performed with additional consideration as to services that are actually offered by the destination web service. In other words, a client or web service that accesses the destination web service may have full rights to all of the services; however, a particular request may be invalid because the requested web-based application is not available from the destination web service. As discussed above, logical module 216 uses WSDL to determine the services that are actually offered by the destination web service.

If the request in the message is not allowed (i.e., the requesting client or web service does not have access to a service or the service is not available), the “No” branch of block 316 is followed, and block 308 may be performed which informs the client or web service that the request contained in the message is denied.

If the request in the message is allowed (i.e., the requesting client or web service has access to an application and the application is available), the “Yes” branch of block 316 is followed, and block 318 is performed.

At block 318, the requesting client or web service is allowed access rights based on the message that is received by firewall server 310. Access rights may be to view a service and/or to use (consume) a service from at the destination web service. In the web service context, access rights typically instruct a destination web service to provide a particular service to the requesting client or web service. The service then sends to the requesting client a reply message such as web service messages 120, and may be formatted as XML data packets or listings which may be part of a SOAP message.

Exemplary Computing Device

FIG. 4 shows an exemplary computing device implemented as firewall server 110 suitable as an environment for practicing aspects of the subject matter, for example to host an exemplary policy manager 204. The components of firewall server 110 may include, but are not limited to, a processing unit 420, a system memory 430, and a system bus 421 that couples various system components including the system memory 430 to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as the Mezzanine bus.

Exemplary firewall server 110 typically includes a variety of computing device-readable media. Computing device-readable media can be any available media that can be accessed by firewall server 110 and includes both volatile and nonvolatile media, removable and non-removable media. By way of example, and not limitation, computing device-readable media may comprise computing device storage media and communication media. Computing device storage media include volatile and nonvolatile, removable and non-removable media implemented in any method or technology for storage of information such as computing device-readable instructions, data structures, program modules, or other data. Computing device storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by firewall server 110. Communication media typically embodies computing device-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computing device readable media.

The system memory 430 includes computing device storage media in the form of volatile and/or nonvolatile memory such as read only memory (ROM) 431 and random access memory (RAM) 432. A basic input/output system 433 (BIOS), containing the basic routines that help to transfer information between elements within computing device 302, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437. Although the exemplary policy manager 204 is depicted as software in random access memory 432, other implementations of an exemplary policy manager can be hardware or combinations of software and hardware.

The exemplary firewall server 110 may also include other removable/non-removable, volatile/nonvolatile computing device storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computing device storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface such as interface 450.

The drives and their associated computing device storage media discussed above and illustrated in FIG. 4 provide storage of computing device-readable instructions, data structures, program modules, and other data for firewall server 110. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the exemplary firewall server 110 through input devices such as a keyboard 448 and pointing device 461, commonly referred to as a mouse, trackball, or touch pad. Other input devices (not shown) may include a microphone, joystick, game pad, satellite dish, scanner, or the like. These and other input devices are often connected to the processing unit 420 through a user input interface 460 that is coupled to the system bus, but may be connected by other interface and bus structures, such as a parallel port, game port, or a universal serial bus (USB). A monitor 462 or other type of display device is also connected to the system bus 421 via an interface, such as a video interface 490. In addition to the monitor 462, computing devices may also include other peripheral output devices such as speakers 497 and printer 496, which may be connected through an output peripheral interface 495.

The exemplary firewall server 110 may operate in a networked environment using logical connections to one or more remote computing devices, such as a remote computing device 480. The remote computing device 480 may be a personal computing device, a server, a router, a network PC, a peer device or other common network node, and typically includes many or all of the elements described above relative to firewall server 110, although only a memory storage device 481 has been illustrated in FIG. 4. The logical connections depicted in FIG. 4 include a local area network (LAN) 471 and a wide area network (WAN) 473, but may also include other networks. Such networking environments are commonplace in offices, enterprise-wide computing device networks, intranets, and the Internet.

When used in a LAN networking environment, the exemplary firewall server 110 is connected to the LAN 471 through a network interface or adapter 470. When used in a WAN networking environment, the exemplary firewall server 110 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the exemplary firewall server 110, or portions thereof, may be stored in the remote memory storage device. By way of example, and not limitation, FIG. 4 illustrates remote application programs 485 as residing on memory device 481. It will be appreciated that the network connections shown are exemplary and other means of establishing a communications link between the computing devices may be used.

It should be noted that the subject matter described above can be implemented in hardware, in software, or in both hardware and software. In certain implementations, the exemplary system, engine, and related methods may be described in the general context of computer-executable instructions, such as program modules, being executed by a television set-top box and/or by a computer. Generally, program modules include routines, programs, objects, components, data structures, etc. that perform particular tasks or implement particular abstract data types. The subject matter can also be practiced in distributed communications environments where tasks are performed over wireless communication by remote processing devices that are linked through a communications network. In a wireless network, program modules may be located in both local and remote communications device storage media including memory storage devices.

### CONCLUSION

The foregoing discussion describes exemplary systems, engines, and methods for firewall servers implementing policies affecting destination web services. Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A firewall device that receives and passes messages to and from a destination web service comprising:
one or more web service filters to verify that a message received by the firewall device is from an authorized client, wherein the one or more filters use policies to verify the message and to define access rights of the authorized client if the message is verified;
a first logical web service processing module to monitor services available from the destination web service, and to determine if a request in the message for a particular service is available from the destination web service; and
a second logical web service processing module to process data representing the request in the message based on the policies that define access rights of the authorized client.

2. The firewall device of claim 1 wherein the one or more web service filters validates that the message has not been altered since originating from the authorized client.

3. The firewall device of claim 1 wherein the one or more web service filters validates that the message is well formed.

4. The firewall device of claim 1 wherein the one or more web service filters comprise one or more transportation protocol layer filters.

5. The firewall device of claim 4, wherein the one or more transportation protocol layer filters use one of the protocols HTTP, SMTP, FTP, or TCP.

6. The firewall device of claim 4, wherein the one or more transportation protocol layer filters changes the transportation protocol of a received or passed message.

7. The firewall device of claim 1 wherein the web service message is an XML listing.

8. The firewall device of claim 1 wherein the web service message is a SOAP message comprising a header and body.

9. The firewall device of claim 8 wherein the one or more web service filters perform verification on the header of the SOAP message.

10. The firewall device of claim 1 wherein the policies are maintained in a separate storage device and are provided to the firewall device.

11. The firewall device of claim 1 wherein the policies are defined by WS-Policy.

12. The firewall device of claim 1 wherein the services provided by the destination web service are described in WSDL, and the first logical web service processing module processes WSDL listings when monitoring the web service.

13. The firewall device of claim 1 wherein the second logical web service processing module validates that the message has not be altered since originating from the authorized client.

14. The firewall device of claim 1 wherein the second logical web service processing module validates that the message is well formed.

15. The firewall device of claim 1 further comprising a third logical web service processing module to perform security negotiation between the destination web service and clients.

16. The firewall device of claim 15 wherein the third logical web service processing module determines whether the message received at the firewall device has been signed and/or encrypted and whether to pass the message received at the firewall device to the destination web service.

17. The firewall device of claim 15 wherein the third logical web service processing module encrypts and signs a digital signature for a message sent by the destination web service.

18. The firewall device of claim 1 further comprising a fourth logical web service processing module that validates that data in the message has not been altered since originally sent from the authorized client.

19. The firewall device of claim 1 further comprising a fifth logical web service processing module used for extensibility for additional data-inspection algorithms separate from the policies.

20. A method of managing policy for a destination web service implemented at a firewall server comprising:
receiving a web service message containing a request for a service at the destination web service;
verifying that the web service message is from an authorized particular client;
applying policies which define access rights to applications of the destination web service that are available to the particular client;
inspecting the request contained in the message as to whether the request is valid per the access rights available to the particular client; and
providing an application if the message is verified, the particular client has access rights, and the request is valid per the access rights available to the particular client.

21. The method of claim 20 wherein the web service message is an XML listing.

22. The method of claim 20 wherein the web service message is a SOAP envelope.

23. The method of claim 20 wherein the receiving is performed over a particular transportation protocol layer.

24. The method of claim 20 wherein the verifying is performed by using a digital signature contained in the web service message.

25. The method of claim 20 wherein the applying policies is based on WS-Policy defining the particular client as a “policy subject” and assigning “policy assertions” that define the access rights of the particular client to applications of the destination web service.

26. The method of claim 20 wherein the inspecting is based on the policies that define the access rights available to the particular client.

27. The method of claim 20 wherein the inspecting comprises determining actual services available from the destination web service and determining if the request in the web service message is included in the actual services available from the destination web service.

28. The method of claim 20 wherein the inspecting comprises validating the web service message.

29. The method of claim 20 wherein the inspecting comprises determining if the request is well formed.

30. The method of claim 20 wherein the providing uses a SOAP envelope that includes the application.

31. The method of claim 20 wherein the providing comprises encrypting the application that is sent to the particular client.

32. The method of claim 20 further comprising sending a message to the particular client if the request in the web service message is denied.

33. The method of claim 20 further comprising validating the web service message.

34. The method of claim 20 further comprising performing security negotiating between the destination web service and clients based on the policies.

35. For use with a firewall device, a storage medium having instructions that, when executed on the firewall computer, performs acts comprising:
receiving requests from clients for applications in a destination web service;
verifying the clients submitting the requests;
determining access rights of the clients to the applications based on policies implemented at the firewall computer; and
providing applications to a client if a request is valid.

36. The storage medium as recited in claim 35, wherein the determining access rights comprises identifying actual applications available at the destination web service.

37. The storage medium as recited in claim 35 further comprising validating the requests.

38. The storage medium as recited in claim 35 further comprising encrypting the application prior to providing the application to the client.

39. A firewall device comprising:
means for receiving web service messages from clients, wherein the web service messages are destined to a web service;
means for verifying that the web service messages are from authorized clients; and
means for applying policies as to applications available to authorized clients from the web service.

40. The firewall device of claim 39 further comprising means for validating that messages are not altered since being sent from the authorized clients.

41. The firewall device of claim 39 further comprising means for providing applications from the web service to the authorized clients if policies allow applications to be provided.

42. The firewall device of claim 39 further comprising means for security negotiation between the web service and the authorized clients.
